(19) United States
(12) Patent Application Publication
(10) Pub. No.: US 2002/0083011 A1
(43) Pub. Date: Jun. 27, 2002

(54) Transaction mediation system and transaction mediation method

(76) Inventor: Koji Kobayashi, Tokyo (JP)

Correspondence Address: McGinn & Gibb, PLLC, 8321 Old Courthouse Road, Suite 200, Vienna, VA, 22182-3817, US

(21) Appl. No.: 10/023,740

(22) Filed: Dec. 21, 2001

(30) Foreign Application Priority Data
Dec. 25, 2000 (JP) 392731/2000

(51) Int. Cl. G06F 17/60

(52) U.S. Cl. 705/64

(57) ABSTRACT

This transaction mediation system includes at least a pay side system, a receiving side system, and a mediation processing system which are connected to each other through a communication network, wherein the mediation processing system comprises units for connecting to the pay side system and the receiving side system, a log-in processing unit, a transaction information obtaining unit for obtaining transaction information from the pay side system, a request information obtaining unit for preparing transaction identification information, sending it to the receiving side system, and obtaining request information prepared by the receiving side system, a transaction permission confirmation unit for preparing transaction permission confirmation information including the amount of the merchandise or the like based on the request information, sending it to the pay side system, obtaining the transaction permission information from the pay side system, and determining to continue/cancel the transaction, and a transaction processing means for conducting the transaction with the receiving side system.

### BACKGROUNDS OF THE INVENTION

1. Field of the Invention

The present invention relates to a transaction mediation system and a transaction mediation method and, more particularly, a transaction mediation system and a transaction mediation method capable of conducting transactions without passing information about a pay side system to a receiving side system.

2. Description of the Related Art

Currently, the spread of personal computers, mobile phones, PDAs, and the likes, as well as the spread of computer networks, especially of the Internet, which accompanies the progress of communication network technologies, allows a large number of people to use personal computers by connecting to the Internet, such that communication is performed at a global scale.

As a result, personal computers, mobile phones, PDAs and the likes are being used for various purposes. For example, online shopping is becoming widespread, in which commercial transactions between a seller side and a purchaser side are conducted through the Internet.

In the conventional online shopping using personal computers, mobile phones, PDAs, and the likes, usually, a purchaser had to communicate personal information such as the name of the purchaser and the credit card number to a seller. In addition, when merchandise is to be delivered to the purchaser's home, the address of the purchaser has to be also communicated. In other words, information related to the privacy of the purchaser was communicated to and recorded on the distributor side. Therefore, if incidents such as the private information leaking happened via the distributor, the purchaser had no means for preventing it.

Further, in a transaction using a credit card number, the seller can perform payment processing once the credit card number is communicated, and does not need to confirm the content of the purchase or the intent to purchase. Therefore, after completion of a transaction between the distributor and the purchaser, if a different merchandise is purchased due to a typing error or the like on the distributor side, the purchaser cannot prevent it.

In the above problems, as a system for preventing personal information from leaking, a system of settling merchandise purchase without communicating a credit card number to distributors is disclosed in Japanese Patent Laid-open (Kokai) No. Heisei 9-282371, Japanese Patent Laid-open (Kokai) No. Heisei 7-129671, and the likes. According to this system, a clearing agency is set up between a consumer (purchaser in the present invention) and an affiliated retail store (seller in the present invention), and the consumer conducts transactions without passing the credit card number itself by using a single-use PIN issued by the clearing agency.

However, since merchandise purchase itself is performed by the consumer and the affiliated retail store even in the above system, when affiliated retail store requires information related to the privacy of the consumer, the consumer can not decline it. Further, since the clearing agency does not provide confirmation on the purchased merchandise to the consumer at the time of closing, the consumer cannot confirm it, if a different merchandise is purchased due to an error of the distributor.

Thus, the conventional online shopping had problems that a transaction could not be conducted without communicating personal information from the purchaser who purchases merchandise or service to the seller, and that when a consumer purchases merchandise or service by margin trading using a credit card company or bank, the actual amount being transferred in the transaction with the distributor could not be confirmed before payment processing from information sources other than the distributor.

### SUMMARY OF THE INVENTION

In consideration of the above problems, a first object of the present invention is to provide a transaction mediation system and a transaction mediation method capable of conducting transactions without communicating personal information of the purchaser to the seller by standing between the seller and the purchaser.

A second object of the present invention is to provide a transaction mediation system and a transaction mediation method capable of preventing the purchaser from conducting an unintended transaction by confirming the content of the transaction including a transaction amount to the purchaser before the transaction is processed, and performing payment processing after obtaining the purchaser's permission.

According to the first aspect of the invention, a transaction mediation system

in which a pay side system and a receiving side system are connected to each other through a mediation processing system,

the mediation processing system comprising

means for obtaining transaction information sent from the pay side system, preparing transaction identification information without including personal information in the pay side system based on the transaction information, and sending the transaction identification information to the receiving side system,

means for obtaining request information prepared by the receiving side system which has received the transaction identification information, preparing transaction permission confirmation information including specific items needed for the confirmation of transaction permission based on the request information, and sending the transaction permission confirmation information to the pay side system, and

means for obtaining transaction permission information sent from the pay side system which has received the transaction permission confirmation information, and determining to continue/cancel the transaction.

In the preferred construction, the receiving side system comprises at least means for connecting to the mediation processing system, means for preparing request information based on the transaction identification information received from the mediation processing system and a transaction database provided in advance, and sending the request information to the mediation processing system, and transaction processing means for conducing the transaction with the mediation processing system.

In another preferred construction, the receiving side system further comprises output means for outputting results processed by the transaction processing means.

In another preferred construction, the pay side system comprises at least means for connecting to the mediation processing system, means for inputting a response to the transaction information and the transaction permission confirmation information, and means for outputting the transaction permission confirmation information.

In another preferred construction, the receiving side system comprises at least means for connecting to the mediation processing system, means for preparing request information based on the transaction identification information received from the mediation processing system and a transaction database provided in advance, and sending the request information to the mediation processing system, and transaction processing means for conducting the transaction with the mediation processing system, and

wherein the pay side system comprises at least means for connecting to the mediation processing system, means for inputting a response to the transaction information and the transaction permission confirmation information, and means for outputting the transaction permission confirmation information.

In another preferred construction, the pay side system is constituted by one of among a mobile phone, a portable terminal, a computer terminal, or a telephone.

In another preferred construction, the transaction permission confirmation information includes at least a name and a transaction amount of merchandise or service dealt with.

According to the second aspect of the invention, a transaction mediation system for mediating a transaction through a network,

the transaction mediation system being constituted by a pay side system, a receiving side system, and an mediation processing system disposed between the pay side system and the receiving side system,

the mediation processing system having at least

means for connecting the pay side system and the receiving side system, means for performing log-in process to the pay side system,

means for obtaining transaction information sent from the pay side system, preparing transaction identification information without including personal information in the pay side system, and sending the transaction identification information to the receiving side system,

means for obtaining request information prepared by the receiving side system receiving the transaction identification information, preparing transaction permission confirmation information including prescribed items needed for the confirmation of transaction permission, and sending the transaction permission confirmation information to the pay side system,

means for obtaining transaction permission information sent from the pay side system which has received the transaction permission confirmation information, and determining to continue/cancel the transaction, and

transaction processing means for conducting the transaction with the receiving side system.

In the preferred construction, the receiving side system has at least means for connecting to the mediation processing system, means for preparing request information based on the transaction identification information received from the mediation processing system and a transaction database provided in advance, and sending the request information to the mediation processing system, and transaction processing means for conducing the transaction with the mediation processing system.

In another preferred construction, the receiving side system further comprises output means for outputting results processed by the transaction processing means.

In another preferred construction, the pay side system comprises at least means for connecting to the mediation processing system, means for inputting a response to the transaction information and the transaction permission confirmation information, and means for outputting the transaction permission confirmation information.

In another preferred construction, the receiving side system comprises at least means for connecting to the mediation processing system, means for preparing request information based on the transaction identification information received from the mediation processing system and a transaction database provided in advance, and sending the request information to the mediation processing system, and transaction processing means for conducing the transaction with the mediation processing system, and

wherein the pay side system comprises at least means for connecting to the mediation processing system, means for inputting a response to the transaction information and the transaction permission confirmation information, and means for outputting the transaction permission confirmation information.

In another preferred construction, the pay side system is constituted by one among a mobile phone, a portable terminal, a computer terminal, or a telephone.

In another preferred construction, the transaction permission confirmation information includes at least a name and a transaction amount of merchandise or service dealt with.

According to another aspect of the invention, a transaction mediation method using a transaction mediation system in which a pay side system and a receiving side system are connected to each other by a network through an mediation processing system,

the mediation processing system including the steps of

obtaining transaction information sent from the pay side system, preparing transaction identification information without including personal information of the pay side system based on the transaction information, and sending the transaction identification information to the receiving side system,

obtaining request information prepared by the receiving side system receiving the transaction identification information, preparing transaction permission confirmation information including prescribed items needed for the confirmation of transaction permission based on the request information, and sending the transaction permission confirmation information to the pay side system, and

obtaining transaction permission information sent from the pay side system which has received the transaction permission confirmation information, and determining to continue/cancel the transaction.

In the preferred construction, the receiving side system comprises at least the steps of preparing request information based on the transaction identification information received from the mediation processing system and a transaction database provided in advance, and sending the request information to the mediation processing system.

In another preferred construction, the receiving side system further comprises a step of outputting results processed by a transaction.

In another preferred construction, the pay side system comprises at least the steps of inputting the transaction information, outputting the transaction permission confirmation information, and inputting a response to the transaction permission confirmation information.

In another preferred construction, the receiving side system comprises at least the steps of preparing request information based on the transaction identification information received from the mediation processing system and a transaction database provided in advance, and sending the request information to the mediation processing system, and

wherein the pay side system comprises at least the steps of inputting the transaction information, outputting the transaction permission confirmation information, and inputting a response to the transaction permission confirmation information.

In another preferred construction, the pay side system is processed by using one among a mobile phone, a portable terminal, a computer terminal, or a telephone.

In another preferred construction, the transaction permission confirmation information includes at least a name and a transaction amount of merchandise or service dealt with.

In another preferred construction, wherein the transaction mediation system mediates selling and buying of merchandise or service.

According to a further aspect of the invention, a transaction mediation method conducting transactions by using a pay side system, a receiving side system, and an mediation processing system disposed between the pay side system and the receiving side system through a network,

the mediation processing system including the steps of

performing log-in process to the pay side system,

obtaining transaction information sent from the pay side system, preparing transaction identification information without including personal information of the pay side system, and sending the transaction identification information to the receiving side system,

obtaining request information prepared by the receiving side system which has received the transaction identification information, preparing transaction permission confirmation information including prescribed items needed for the confirmation of transaction permission based on the request information, and sending the transaction permission confirmation information to the pay side system,

obtaining transaction permission information sent from the pay side system which has received the transaction permission confirmation information, and determining to continue/cancel the transaction, and

conducing the transaction with the receiving side system when continuation of the transaction is permitted.

In the preferred construction, the receiving side system comprises at least the steps of preparing request information based on the transaction identification information received from the mediation processing system and a transaction database provided in advance, and sending the request information to the mediation processing system.

In another preferred construction, the receiving side system further comprises a step of outputting results processed by a transaction.

In another preferred construction, the pay side system comprises at least the steps of inputting the transaction information, outputting the transaction permission confirmation information, and inputting a response to the transaction permission confirmation information.

In another preferred construction, the receiving side system comprises at least the steps of preparing request information based on the transaction identification information received from the mediation processing system and a transaction database provided in advance, and sending the request information to the mediation processing system, and

wherein the pay side system comprises at least the steps of inputting the transaction information, outputting the transaction permission confirmation information, and inputting a response to the transaction permission confirmation information.

In another preferred construction, processing of the pay side system is performed by using one among a mobile phone, a portable terminal, a computer terminal, or a telephone.

In another preferred construction, the transaction permission confirmation information includes at least a name and a transaction amount of merchandise or service dealt with.

In another preferred construction, the transaction mediation system mediates selling and buying of merchandise or service.

The pay side system of the present invention preferably includes at least the steps of inputting the transaction information, outputting the transaction permission confirmation information, and inputting a response to the transaction permission confirmation information.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a diagrammatic view showing the structure of a transaction mediation system according to an embodiment of the present invention;

FIG. 2 is a flowchart showing the operation of a transaction mediation system according to an embodiment of the present invention;

FIG. 3 is a diagrammatic view showing the structure of a transaction mediation system according to a concrete example of the present invention;

FIG. 4 is a drawing showing the operation of a transaction mediation system according to a concrete example of the present invention;

FIG. 5 is a flowchart showing the operation of a transaction mediation system according to a concrete example of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

A preferred embodiment of a transaction mediation system of the present invention includes at least a pay side system 30, a receiving side system 10, and an mediation processing system 20 disposed therebetween which are connected through a communication network 2, the mediation processing system 20 having at least communication units 27, 21 for connecting the pay side system 30 and the receiving side system 10, a log-in processing unit 25 for performing process of logging into the pay side system, a transaction information obtaining unit 24 for obtaining transaction information sent from the pay side system 30, a request information obtaining unit 23 for preparing transaction identification information which includes items needed for the transaction without including personal information on the pay side system and sending it to the receiving side system to obtain request information prepared by the receiving side system 10 based on the transaction identification information, a transaction permission confirmation unit 26 for preparing, based on the request information, transaction permission confirmation information which includes at least the name of the merchandise or service and the amount, sending it to the pay side system 30, and obtaining the transaction permission information sent from the pay side system 30 against the transaction permission confirmation information to determine the continuation/cancellation of the transaction, and a transaction processing unit 22 for conducting the transaction with the receiving side system.

The above configuration prevents personal information on the pay side system 30 from leaking, by exchanging transaction identification information, without including personal information, between the receiving side system 10 and the mediation processing system 20, and prevents a transaction unintended by the pay side system 30, by confirming the transaction using a transaction permission confirmation information, which includes the name of the merchandise or the like and the amount of money, between the pay side system 30 and the mediation processing system 20.

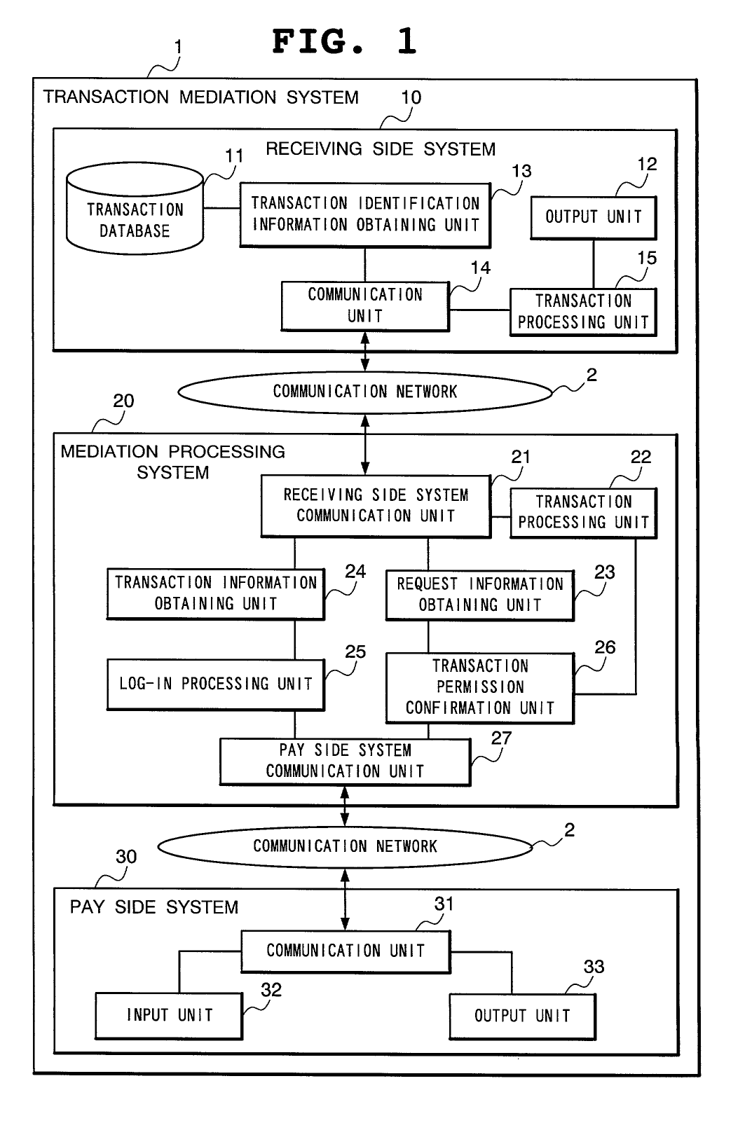

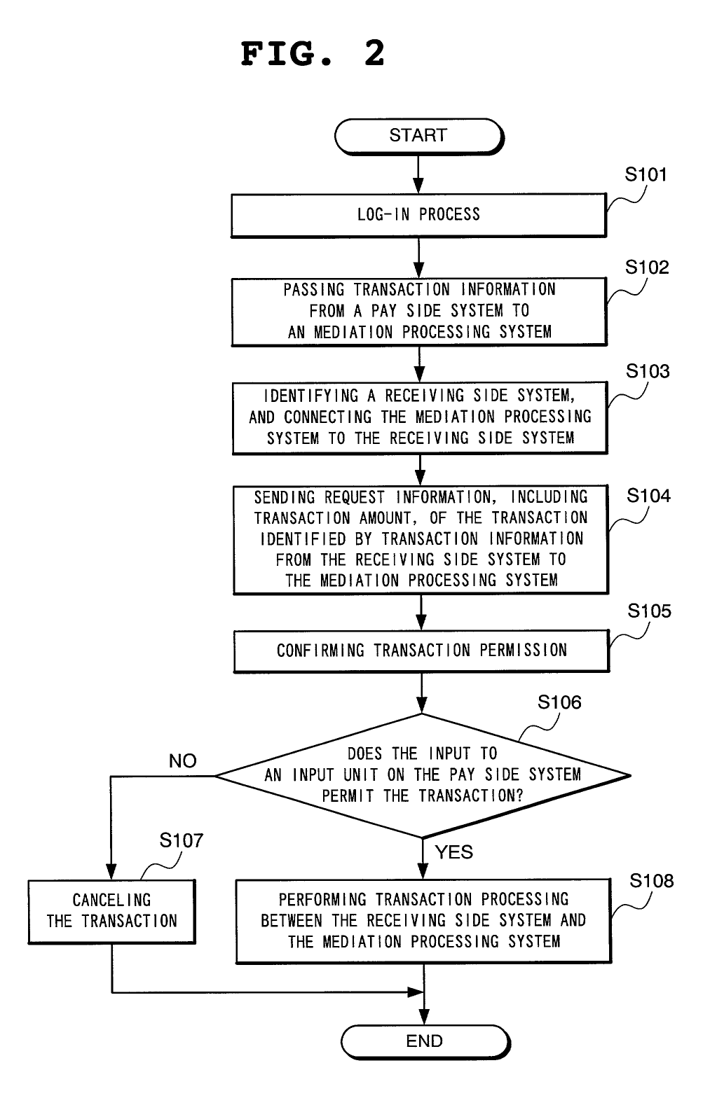

The transaction mediation system and a transaction mediation method using the system will be described in detail with reference to FIGS. 1 and 2. FIG. 1 is a drawing showing the structure of a transaction mediation system related to an embodiment of the present invention, and FIG. 2 is a flowchart showing a transaction procedure according to a transaction mediation system of the present invention.

As shown in FIG. 1, the transaction mediation system 1 according to an embodiment of the present invention consists of a receiving side system 10 which serves as a system on a distributor side, a pay side system 30 which serves as a system on a purchaser side, and an mediation processing system 20 disposed between the receiving side system 10 and the pay side system 30.

The receiving side system 10 is a computer capable of connecting to a network such as a POS terminal and a POT terminal, has a communication unit 14, a transaction database 11, a transaction identification information obtaining unit 13, a transaction processing unit 15, and in some cases, may have an output unit 12.

The communication unit 14 is a means for exchanging information between the receiving side system 10 and the mediation processing system 20, and exchanges the transaction identification information, the request information, and the transaction processing information. The transaction database 11 stores the information about the transaction.

The transaction identification information obtaining unit 13 receives the transaction identification information from the mediation processing system 20 through the communication unit 14, retrieves information about the transaction identified by the information from the transaction database 11, and sends request information to the mediation processing system 20. The transaction processing unit 15 performs transaction processing with the mediation processing system 20, and the output unit 12 outputs the result of the transaction process.

The mediation processing system 20 has a log-in processing unit 25, a pay side system communication unit 27, a receiving side system communication unit 21, the transaction information obtaining unit 24, the request information obtaining unit 23, the transaction permission confirmation unit 26, and the transaction processing unit 22.

The pay side system communication unit 27 is a means for communicating with the pay side system 30, and the log-in processing unit 25 is a means for performing log-in processing of the pay side system 30. Log-in information, transaction information, transaction confirmation information and the likes are exchanged through this means. The receiving side system communication unit 21 is a means for communicating with the receiving side system 10, and transaction identification information, request information, transaction processing information, and the likes are exchanged through this means.

The transaction information obtaining unit 24 is a means for obtaining the transaction information from the pay side system 30 using the pay side system communication unit 27. The request information obtaining unit 23 is a means for sending the transaction identification information to the receiving side system 10 using the receiving side system communication unit 21, and obtaining request information from the receiving side system 10.

The transaction permission confirmation unit 26 is a means for preparing the transaction permission confirmation information from the request information, and sending the transaction permission confirmation information to the pay side system 30 using the pay side system communication unit 27. Subsequently, the transaction permission confirmation unit 26 receives a result confirmed by the purchaser whether the purchaser permits the transaction conducted on the system, and determines whether to perform the transaction processing. A transaction unit 22 conducts the transaction with the receiving side system 10.

The pay side system 30 is a system that can be connected to communication networks of mobile phones, portable terminals, computers, telephones, and the likes, and includes an input unit 32, an output unit 33, and the communication unit 31.

The input unit 32 is a means by which the purchaser inputs information into the pay side system 30, and a general device may be utilized, in particular, buttons, keyboards, dials, pointing devices, mice, touch pads, bar code readers, cameras, microphones and the likes may be cited. The output unit 33 is a means by which the purchaser obtains information from the pay side system 30, and a general device may be utilized, in particular, displays, speakers, printers and the likes may be cited. The communication unit 31 is a means for exchanging information between the pay side system 30 and the mediation processing system 20. Log-in information, the transaction information, and the transaction confirmation information are exchanged using this means.

The pay side system 30 and the mediation processing system 20, as well as the mediation processing system 20 and the receiving side system 10 are connected to each other through a communication network 2. The communication network 2 may be either an exclusive system using a private line, or an open system such as the Internet.

In addition, it is evident that anti-wiretapping measures such as encryption technologies can be enforced so that the communications between the pay side system 30 and the mediation processing system 20, and between the mediation processing system 20 and the receiving side system 10 are not intercepted. Furthermore, it is evident that existing authentication technology, personal identification technology, and personal authentication technology can be enforced so that a pay side system 30 or a receiving side system 10 is not misidentified as another pay side system 30 or another receiving side system 10.

Next, information exchanged between each of the systems will be described. First, the log-in information, the transaction information, and the transaction confirmation information are exchanged between the pay side system 30 and the mediation processing system 20 through the communication network 2.

The log-in information is the information exchanged when the pay side system 30 logs into the mediation processing system 20.

The transaction information is the information for identifying the receiving side system 10 and the transaction which the purchaser conducts with the receiving side system 10 or the distributor which has the receiving side system 10. The transaction information includes, for example, a combination of the name of the shop that owns the receiving side system 10 and the merchandise purchased by the purchaser, or a distributor group sharing a given receiving side system 10 and a transaction serial number usable within the group. Or, for each specific service purchased by the purchaser, such as a meal, the serial number that identifies the service may be received.

The transaction permission confirmation information is the information exchanged to confirm whether the purchaser permits the transaction conducted on the system.

The transaction identification information, the request information, the transaction processing information, and the likes are exchanged between the mediation processing system 20 and the receiving side system 10 through the communication network 2.

The transaction identification information is the information capable of identifying the transaction within the receiving side system 10, and is prepared based on the transaction information sent from the pay side system 30 by extracting only items needed for the transaction without including personal information on the pay side system 30.

The request information is the information about the transaction identified by the transaction identification information. The request information necessarily includes the information on the amount of money (hereafter referred to as transaction amount) exchanged in the transaction. It may also include other information on the transaction, for example, the name and the summary of the merchandise and service, the transaction date, and the likes.

The transaction processing information is the information exchanged when the transaction is processed.

Next, transaction procedure using a transaction mediation system having the above structure will be described with reference to FIG. 2.

First, the purchaser has to obtain the transaction information before using the system. However, the method for obtaining the transaction information is not particularly limited. The purchaser may ask a sales assistant or check on the Web site.

In S101, the purchaser then logs into the transaction mediation system 20 using the input unit 32 of the pay side system 30. The log-in process serves to identify the purchaser, and an existing personal authentication method may be used. For example, a password, a magnetic card, or an IC card, or authentication using a fingerprint, a face form, a retinal/iridial pattern, a palm form, a voice pattern, voice, or handwriting, or the combination thereof may be cited. The purchaser may be the owner of the pay side system 30 such as a mobile phone, and when the owner is obvious, the process may be automated.

After the logging-in, in S102, the purchaser inputs the transaction information to the pay side system 30. The inputted transaction information is sent to the mediation processing system 20 by the communication unit 31, through the communication network 2. The mediation processing system 20 identifies the receiving side system 10 from the transaction information and connects to the receiving side system 10 in S103.

After the connection, in S104, the mediation processing system 20 prepares the transaction identification information to identify the transaction from the transaction information, and sends it to the connected receiving side system 10. The receiving side system 10 searches for the information about the transaction identified by the transaction identification information from the transaction database 11, and prepares the request information based on the information. Once prepared, the request information is sent to the mediation processing system 20.

The request information necessarily includes the information on the amount of money (hereafter referred to as transaction amount) exchanged in the transaction. It may also contain other information related to the transaction, for example, the name and the summary of merchandise and service, the transaction date, and the likes.

Next, in S105, the mediation processing system 20 prepares the transaction permission confirmation information based on the request information. The mediation processing system 20 then outputs the transaction permission confirmation information to the output unit 33 on the pay side system 30 in order to communicate the transaction permission confirmation information to the purchaser. The transaction permission confirmation information includes the transaction amount. It may also include other information that is or is not included in the request information.

Next, in S106, the purchaser confirms the transaction permission confirmation information and enters into the input unit 32 of the pay side system 30 whether the purchaser permits the transaction. When the response to the transaction permission confirmation is entered into the pay side system 30, the content is passed to the mediation processing system 20 and confirmed by the transaction permission confirmation unit 26.

When the content of the response permits the transaction, the mediation processing system 20 conducts the transaction with the receiving side system 10 in S108. In so doing, the mediation processing system 20 uses the request information. On the other hand, when the content of the response does not permit the transaction, the transaction is canceled in S107.

Incidentally, the transaction process performed here may use existing transaction processes. In some cases, the receiving side system 10 may have the output unit 12 for outputting the transaction result in order to confirm the transaction result after the transaction is achieved between the mediation processing system 20 and the receiving side system 10.

Thus, by conducting the transaction using the transaction mediation system 1 according to an embodiment of the present invention, the transaction can be conducted without communicating personal information of the purchaser to the seller side. Further, by conducting the transaction using the system, unintended transactions can be prevented since the content of the transaction including the transaction amount is confirmed by the purchaser before the transaction is processed, and the transaction processing is performed after the purchaser's permission has been obtained.

### Concrete Example

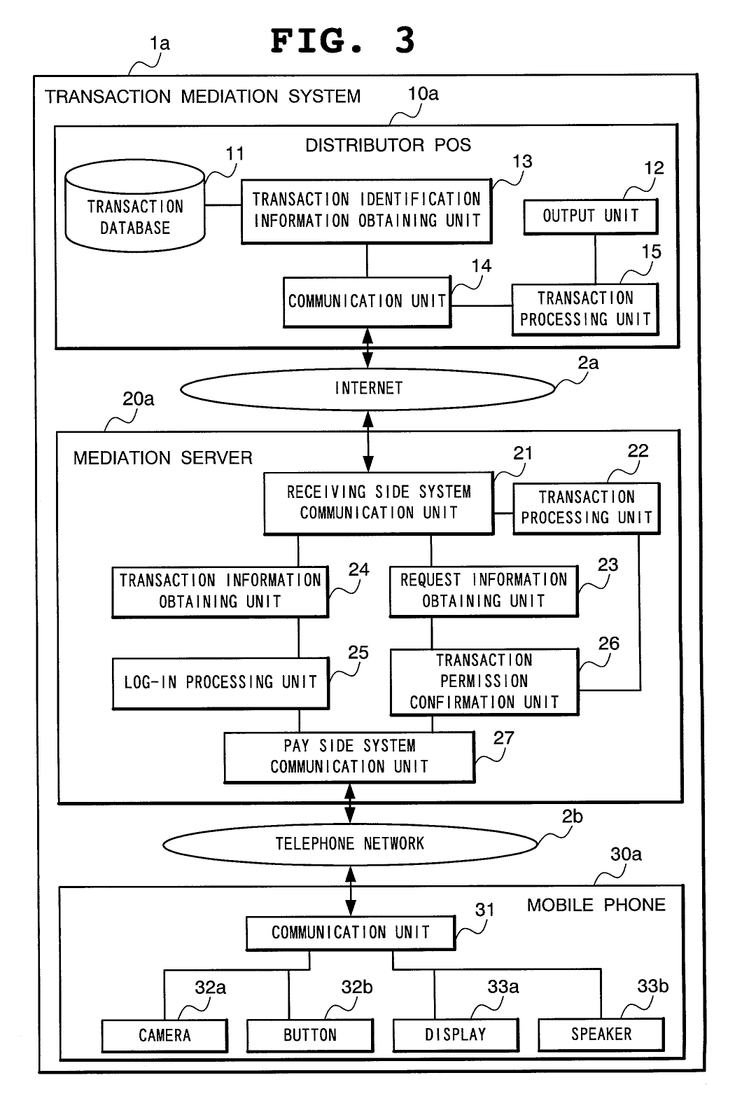

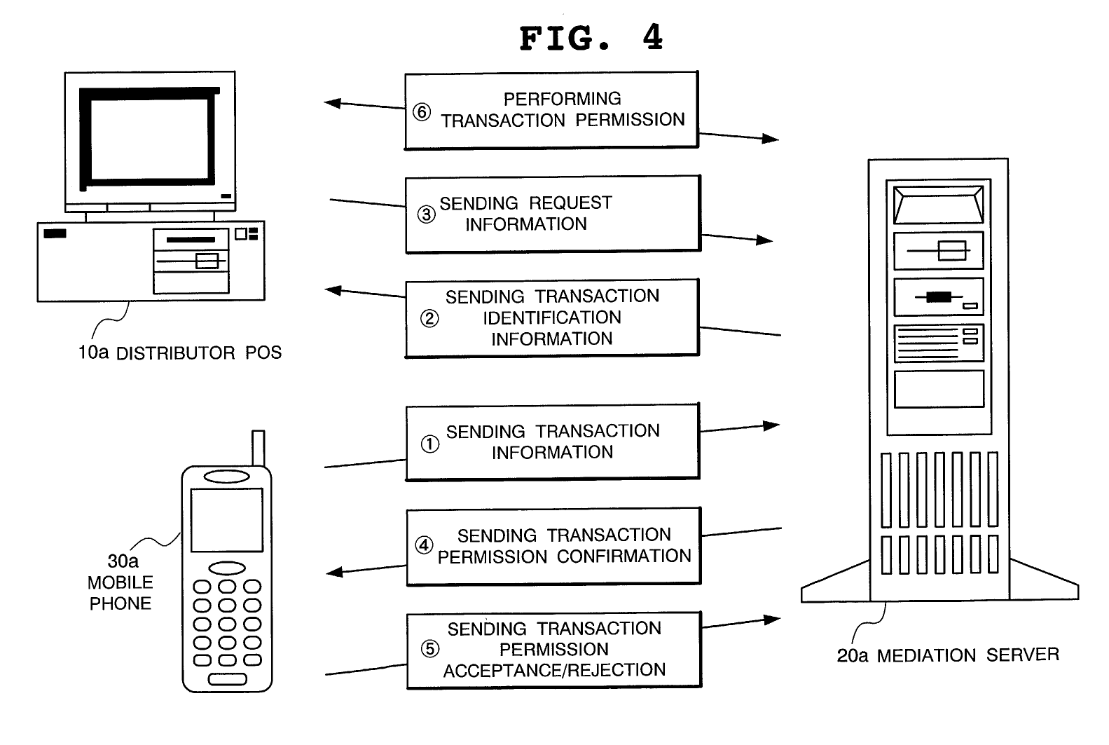

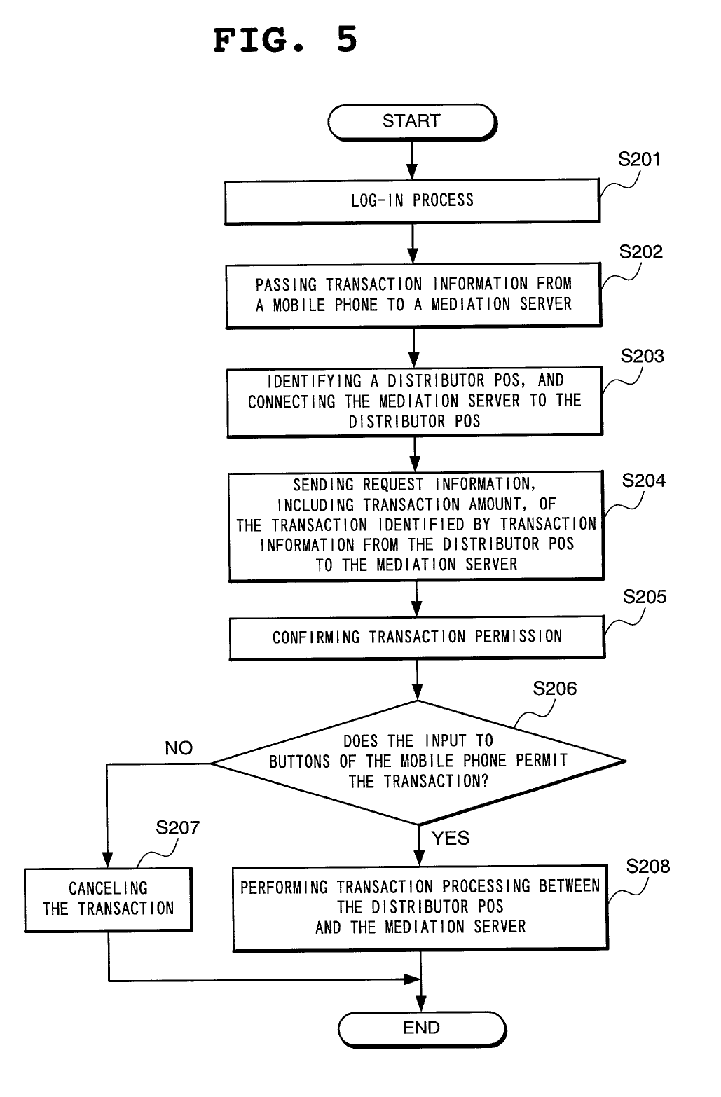

In order to describe the above-mentioned embodiment of the present invention in further details, a concrete example showing a concrete case will be described with reference to FIGS. 3 through 5. FIG. 3 is a diagrammatic view showing the structure of a transaction mediation system according to a concrete example of the present invention. FIG. 4 is a drawing showing in schematic form the operation of a transaction mediation system according to a concrete example of the present invention, and FIG. 5 is a flowchart showing a concrete transaction procedure. In addition, the concrete example will be described assuming the payment of meal expenses at a restaurant.

As shown in FIG. 3, the transaction mediation system 1a of the concrete example consists of the pay side system 30, the receiving side system 10, and the mediation processing system 20, and especially, uses a mobile phone as the pay side system 30, a POS system as the receiving side system 10, and a server system owned by a telephone company as the mediation processing system 20 (hereafter the pay side system 30 of the concrete example is referred to as a mobile phone 30a, the receiving side system 10 is referred to as a distributor POS 10a, and the mediation processing system 20 is referred to as an mediation server 20a).

These systems are connected by the communication network. The mobile phone 30a and the mediation server 20a can be connected by a telephone network 2b, and the mediation server 20a and the distributor POS 10a can be connected by the Internet 2a. Wire-tapping between the mediation server 20a and the distributor POS 10a is prevented by SSL, and the distributor POS 10a can be identified by an authentication authority.

The mobile phone 30a has a button 32a and a camera 32b as the input unit 32. In addition, the camera 32b can not only take pictures but also read bar codes. It has also a display 33a and a speaker 33b as the output unit 33. Further, it has also a transaction information communication unit 31 for sending the transaction information to the mediation processing system 20. In this case, the transaction information includes two serial numbers: one is to identify the distributor POS 10a and the other is assigned to each meal expense.

The mediation server 20a includes the log-in processing unit 25 for processing log-in to the transaction mediation system 1 of the purchaser, the transaction information obtaining unit 24 for receiving the transaction information from the mobile phone 30a, the receiving side system communication unit 21 for identifying the distributor POS 10a from the transaction information and connecting to the distributor POS 10a, the request information obtaining unit 23 for receiving the request information on the transaction identified by the transaction information from the connected distributor POS 10a, the transaction permission confirmation unit 26 for outputting the transaction confirmation information to the display 33a and to the speaker 33b on the mobile phone 30a to confirm the acceptance or the rejection of the transaction to the purchaser, and the transaction processing unit 22 for performing the transaction process with the distributor POS 10a.

The request information includes a total amount of the meal and a breakdown of the amount, and the transaction confirmation information includes the name of the restaurant which has the distributor POS 10a, and the total amount of the meal.

The distributor POS 10a has an mediation server 20a—a distributor POS 10a communication unit 14 for connecting to the mediation server 20a, a transaction identification information obtaining/request information preparing unit 13 for receiving the transaction information from the mediation server 20a and for sending the request information of the transaction identified by the transaction information, and the transaction processing unit 15 for performing the transaction processing with the mediation server 20a, and the output unit 12 such as a printer for outputting the transaction conducted with the mediation processing system.

Next, concrete transaction procedure will be described using the transaction mediation system 1a having the above structure with reference to FIGS. 4 and 5.

In addition, in the concrete example, it is assumed that the transaction information has been communicated to the service purchaser (hereafter simply referred to as the purchaser) who pays the meal expenses, by the distributor. Any methods may be applied to receive the transaction information from the distributor. For example, the purchaser may receive an output printed by a printer of the distributor, or get oral description from a sales assistant who operates the distributor POS 10a. Further, it is assumed that the information about the transaction in which the purchaser pays the expenses is already recorded in the transaction database 11 of the distributor POS 10a.

First of all, the purchaser using the system logs into the transaction mediation server 20a from the mobile phone 30a, in S201.

Next, in S202, the purchaser inputs the transaction information obtained from the distributor POS 10a by using the buttons 32a of the mobile phone 30a or reading the bar code with the camera 32b. The transaction information is sent to the mediation server 20a through a telephone network 2b (see FIG. 4-1).

Subsequently, in S203, after receiving the transaction information, the mediation server 20a identifies the distributor POS 10a based on the transaction information to prepare the transaction identification information, and connects to the purchaser POS 10a through the Internet network 2a (see FIG. 4-2). In so doing, SSL should be used to prevent interception.

Then, in S204, the mediation server 20a receives the request information about the transaction identified by the transaction information from the distributor POS 10a (see FIG. 4-3). The request information includes the transaction amount. In 205, the mediation server 20a then outputs the transaction confirmation information to the display 33a and the speaker 33b of the mobile phone 30a (see FIG. 4-4). The purchaser confirms the content outputted from the display and the speaker, and inputs the acceptance/rejection of the transaction using the buttons of the mobile phone 30a (see FIG. 4-5).

Next, in S206, when receiving the input to the mobile phone 30a after outputting the transaction confirmation information, the mediation server 20a determines whether the input permits the transaction. When the input permits the transaction, the mediation server 20a performs the transaction processing with the distributor POS 10a using the transaction processing unit 22 (S208, see FIG. 4-6). Subsequently, the distributor POS 10a outputs the transaction content to the printer after completion of the transaction processing, and the transaction mediation system stops. If the input does not permit the transaction, the mediation server 20a cancels the transaction (S207). Then, the transaction mediation stops.

Thus, according to the transaction mediation system and the transaction mediation method of the concrete example, a transaction can be conducted without communicating personal information of the purchaser to the seller, and unintended transaction can be prevented since the content of the transaction including the transaction amount is confirmed by the purchaser before the transaction is processed, and the transaction process is performed after obtaining the purchaser's permission.

In addition, a transaction mediation system and a transaction mediation method have been described in the concrete example, assuming a payment of meal expenses at a restaurant, however, it is clear that the present invention is not limited to the above-mentioned concrete example, and that it can be applied to any business in which purchasers purchase merchandise and service from providers through communication networks.

Further, when purchasing merchandise or the like, the purchaser can obtain the merchandise without communicating the address of the purchaser to the seller. For example, there are methods for receiving the merchandise such as poste restante, a post office box, laying away service of a convenience store, and forwarding service which forwards a merchandise sent to a specified address.

Since a conventional method may be used, a method of payment to providers of service by using the transaction mediation system is not prescribed in particular. For example, there are methods such as the amount is deducted from the bank account of the purchaser identified by log-in, on a monthly or a transaction basis, or the purchaser pays the amount when the merchandise is delivered.

As described above, according to the transaction mediation system and the transaction mediation method of the present invention, a transaction can be conducted without communicating personal information of the purchaser to the seller, and unintended transaction can be prevented since the content of the transaction including the transaction amount is confirmed by the purchaser before the transaction is processed, and the transaction process is performed after obtaining the purchaser's permission.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A transaction mediation system
in which a pay side system and a receiving side system are connected to each other through a mediation processing system,
said mediation processing system comprising:
means for obtaining transaction information sent from said pay side system, preparing transaction identification information without including personal information in said pay side system based on the transaction information, and sending the transaction identification information to said receiving side system;
means for obtaining request information prepared by said receiving side system which has received the transaction identification information, preparing transaction permission confirmation information including specific items needed for the confirmation of transaction permission based on the request information, and sending the transaction permission confirmation information to said pay side system; and
means for obtaining transaction permission information sent from said pay side system which has received the transaction permission confirmation information, and determining to continue/cancel the transaction.

2. A transaction mediation system as set forth in claim 1, wherein
said receiving side system comprises at least means for connecting to said mediation processing system, means for preparing request information based on the transaction identification information received from said mediation processing system and a transaction database provided in advance, and sending the request information to said mediation processing system, and transaction processing means for conducing the transaction with said mediation processing system.

3. A transaction mediation system as set forth in claim 2, wherein
said receiving side system further comprises output means for outputting results processed by said transaction processing means.

4. A transaction mediation system as set forth in claim 1, wherein
said pay side system comprises at least means for connecting to said mediation processing system, means for inputting a response to the transaction information and the transaction permission confirmation information, and means for outputting the transaction permission confirmation information.

5. A transaction mediation system as set forth in claim 1, wherein
said receiving side system comprises at least means for connecting to said mediation processing system, means for preparing request information based on the transaction identification information received from said mediation processing system and a transaction database provided in advance, and sending the request information to said mediation processing system, and transaction processing means for conducting the transaction with said mediation processing system, and
wherein said pay side system comprises at least means for connecting to said mediation processing system, means for inputting a response to the transaction information and the transaction permission confirmation information, and means for outputting the transaction permission confirmation information.

6. A transaction mediation system as set forth in claim 4, wherein
said pay side system is constituted by one of among a mobile phone, a portable terminal, a computer terminal, or a telephone.

7. A transaction mediation system as set forth in claim 1, wherein
said transaction permission confirmation information includes at least a name and a transaction amount of merchandise or service dealt with.

8. A transaction mediation system for mediating a transaction through a network,
said transaction mediation system being constituted by a pay side system, a receiving side system, and an mediation processing system disposed between said pay side system and said receiving side system,
said mediation processing system having at least
means for connecting said pay side system and said receiving side system, means for performing log-in process to said pay side system,
means for obtaining transaction information sent from said pay side system, preparing transaction identification information without including personal information in said pay side system, and sending the transaction identification information to said receiving side system,
means for obtaining request information prepared by said receiving side system receiving the transaction identification information, preparing transaction permission confirmation information including prescribed items needed for the confirmation of transaction permission, and sending the transaction permission confirmation information to said pay side system,
means for obtaining transaction permission information sent from said pay side system which has received the transaction permission confirmation information, and determining to continue/cancel the transaction, and
transaction processing means for conducting the transaction with said receiving side system.

9. A transaction mediation system as set forth in claim 8, wherein
said receiving side system has at least means for connecting to said mediation processing system, means for preparing request information based on the transaction identification information received from said mediation processing system and a transaction database provided in advance, and sending the request information to said mediation processing system, and transaction processing means for conducing the transaction with said mediation processing system.

10. A transaction mediation system as set forth in claim 9, wherein
said receiving side system further comprises output means for outputting results processed by said transaction processing means.

11. A transaction mediation system as set forth in claim 8, wherein
said pay side system comprises at least means for connecting to said mediation processing system, means for inputting a response to the transaction information and the transaction permission confirmation information, and means for outputting the transaction permission confirmation information.

12. A transaction mediation system as set forth in claim 8, wherein
said receiving side system comprises at least means for connecting to said mediation processing system, means for preparing request information based on the transaction identification information received from said mediation processing system and a transaction database provided in advance, and sending the request information to said mediation processing system, and transaction processing means for conducing the transaction with said mediation processing system, and
wherein said pay side system comprises at least means for connecting to said mediation processing system, means for inputting a response to the transaction information and the transaction permission confirmation information, and means for outputting the transaction permission confirmation information.

13. A transaction mediation system as set forth in claim 11, wherein
said pay side system is constituted by one among a mobile phone, a portable terminal, a computer terminal, or a telephone.

14. A transaction mediation system as set forth in claim 8, wherein
said transaction permission confirmation information includes at least a name and a transaction amount of merchandise or service dealt with.

15. A transaction mediation method using a transaction mediation system in which a pay side system and a receiving side system are connected to each other by a network through an mediation processing system,
said mediation processing system including the steps of:
obtaining transaction information sent from said pay side system, preparing transaction identification information without including personal information of the pay side system based on the transaction information, and sending the transaction identification information to said receiving side system;
obtaining request information prepared by said receiving side system receiving the transaction identification information, preparing transaction permission confirmation information including prescribed items needed for the confirmation of transaction permission based on the request information, and sending the transaction permission confirmation information to said pay side system; and
obtaining transaction permission information sent from said pay side system which has received the transaction permission confirmation information, and determining to continue/cancel the transaction.

16. A transaction mediation method as set forth in claim 15, wherein
said receiving side system comprises at least the steps of preparing request information based on the transaction identification information received from said mediation processing system and a transaction database provided in advance, and sending the request information to said mediation processing system.

17. The transaction mediation method as set forth in claim 16, wherein
said receiving side system further comprises a step of outputting results processed by a transaction.

18. The transaction mediation method as set forth in claim 15, wherein
said pay side system comprises at least the steps of inputting the transaction information, outputting the transaction permission confirmation information, and inputting a response to the transaction permission confirmation information.

19. A transaction mediation method as set forth in claim 15, wherein
said receiving side system comprises at least the steps of preparing request information based on the transaction identification information received from said mediation processing system and a transaction database provided in advance, and sending the request information to said mediation processing system, and
wherein said pay side system comprises at least the steps of inputting the transaction information, outputting the transaction permission confirmation information, and inputting a response to the transaction permission confirmation information.

20. A transaction mediation method as set forth in claim 18, wherein
said pay side system is processed by using one among a mobile phone, a portable terminal, a computer terminal, or a telephone.

21. A transaction mediation method as set forth in claim 15, wherein
said transaction permission confirmation information includes at least a name and a transaction amount of merchandise or service dealt with.

22. A transaction mediation method as set forth in claim 15, wherein
said transaction mediation system mediates selling and buying of merchandise or service.

23. A transaction mediation method conducting transactions by using a pay side system, a receiving side system, and an mediation processing system disposed between said pay side system and said receiving side system through a network,
said mediation processing system including the steps of:
performing log-in process to said pay side system;
obtaining transaction information sent from said pay side system, preparing transaction identification information without including personal information of said pay side system, and sending the transaction identification information to said receiving side system,
obtaining request information prepared by said receiving side system which has received the transaction identification information, preparing transaction permission confirmation information including prescribed items needed for the confirmation of transaction permission based on the request information, and sending the transaction permission confirmation information to said pay side system;
obtaining transaction permission information sent from said pay side system which has received the transaction permission confirmation information, and determining to continue/cancel the transaction, and
conducing the transaction with said receiving side system when continuation of the transaction is permitted.

24. A transaction mediation method as set forth in claim 23, wherein
said receiving side system comprises at least the steps of preparing request information based on the transaction identification information received from said mediation processing system and a transaction database provided in advance, and sending the request information to said mediation processing system.

25. A transaction mediation method as set forth in claim 24, wherein
said receiving side system further comprises a step of outputting results processed by a transaction.

26. A transaction mediation method as set forth in claim 23, wherein
said pay side system comprises at least the steps of inputting the transaction information, outputting the transaction permission confirmation information, and inputting a response to the transaction permission confirmation information.

27. A transaction mediation method as set forth in claim 23, wherein
said receiving side system comprises at least the steps of preparing request information based on the transaction identification information received from said mediation processing system and a transaction database provided in advance, and sending the request information to said mediation processing system, and
wherein said pay side system comprises at least the steps of inputting the transaction information, outputting the transaction permission confirmation information, and inputting a response to the transaction permission confirmation information.

28. A transaction mediation method as set forth in claim 26, wherein
processing of said pay side system is performed by using one among a mobile phone, a portable terminal, a computer terminal, or a telephone.

29. A transaction mediation method as set forth in claim 23, wherein
said transaction permission confirmation information includes at least a name and a transaction amount of merchandise or service dealt with.

30. A transaction mediation method as set forth in claim 23, wherein
said transaction mediation system mediates selling and buying of merchandise or service.
